(19) United States
(12) Patent Application Publication
(10) Pub. No.: US 2017/0203558 A1
(43) Pub. Date: Jul. 20, 2017

(54) APPARATUS AND METHOD FOR PLACING COMPONENTS ON AN ELECTRONIC CIRCUIT

(71) Applicant: R.R. DONNELLEY & SONS COMPANY, Chicago, IL (US)

(72) Inventors: Theodore F. Cyman, JR., Grand Island, NY (US); Alan R. Murzynowski, Grand Island, NY (US); Daniel E. Kanfoush, Grand Island, NY (US)

(21) Appl. No.: 14/996,413

(22) Filed: Jan. 15, 2016

(51) Int. Cl. B32B 37/12; B32B 37/06; B32B 37/10

(52) U.S. Cl. CPC B32B 37/1207; B32B 37/10; B32B 37/06; B32B 2457/08; B32B 2307/202; B32B 2037/1215

(57) ABSTRACT

An apparatus and method for placing components on an electronic circuit is disclosed. An adhesive applicator applies an adhesive to the electronic circuit. A component pick-and-place head places a component on the adhesive. A heater supplies sufficient heat to the electronic circuit to melt the adhesive and an outer portion of a contact pin of the component.

### FIELD OF DISCLOSURE

The present subject matter relates to production of devices that include an electronic circuit, and more particularly, to placement of surface mount electronic components on an electronic circuit.

### BACKGROUND

A component placement system or pick-and-place system such as one manufactured by, for example, Universal Instruments Corporation of Conklin, N.Y., or JUKI Automation Systems of Morrisville, N.C., may be used to place surface mount electronic components at predefined locations of conductive traces of an electronic circuit.

The components may be typically disposed in single file on a paper or plastic tape and adhered thereto. The tape then may be wound on a reel. The component placement system typically includes one or more reel stands, and a reel of tape may be mounted on such a reel stand to supply components to the component placement system. Each reel may include identical components or different types of components.

The conductive traces of the electronic circuit may be deposited by printing or etching on a surface of a non-flexible, printed circuit board. The printed circuit board may be secured to a conveyer belt, for example by a clamp and/or a vacuum source. The conveyer belt may be operated to move the printed circuit board into a placement area of the component placement system. An adhesive dispenser may eject dabs of adhesive at the predetermined positions where components are to be placed. A moveable pick-and-place head, that may be coupled a vacuum source, may be electronically controlled to move to a component on the reel, use suction from the vacuum source to pick up the component, and transport the component to the predetermined position on the printed circuit board. The suction then may be released to allow the component to separate from the pick-and-place head. The dab of adhesive on the printed circuit board keeps the component in place. After all of the components that are to be deposited by the placement system have been placed in this manner, the conveyor may be operated to transport the printed circuit board out of the placement system. Thereafter, wave soldering and/or other bonding processes may be used to bond pins of each component to conductive traces of the electronic circuit.

### SUMMARY

According to one aspect, an apparatus to place components on an electronic circuit includes an adhesive applicator, a component pick-and-place head, and a heater. The adhesive applicator is adapted to deposit an adhesive on the electronic circuit. The component pick-and-place head is adapted to place a component on the adhesive. The heater is adapted to supply sufficient heat to the electronic circuit to melt both the adhesive and an outer portion of a contact pin of the component.

According to another aspect, a method for placing components on an electronic circuit includes the steps of depositing an adhesive on the electronic circuit, placing a component on the adhesive, and supplying sufficient heat to the electronic circuit to melt the adhesive and melt an outer portion of a contact pin of the component.

### BRIEF DESCRIPTION OF THE DRAWINGS

FIG. 1 is a combined isometric and block diagram of a component placement system;

FIG. 2 is a block diagram of a placement subassembly of the component placement system of FIG. 1;

FIG. 3 is a block diagram of another placement subassembly of the component placement system of FIG. 1;

FIG. 4. is an isometric diagram of an adhesive pan of the component placement system of FIG. 1;

FIG. 5 is a cross-sectional view taken along a line 5-5 of the adhesive pan of FIG. 4;

FIG. 6 is a block diagram of a pressure applicator of the component placement system of FIG. 1;

FIG. 7A is a top plan view of an electronic circuit that may be assembled by the component placement system of FIG. 1;

FIGS. 7B and 7C are cross-sectional views taken along the line 7B-7B of the electronic circuit of FIG. 7A; and

FIG. 8 is a block diagram of another component placement system.

Other aspects and advantages will become apparent upon consideration of the following detailed description and the attached drawings wherein like numerals designate like structures throughout the specification.

### DETAILED DESCRIPTION

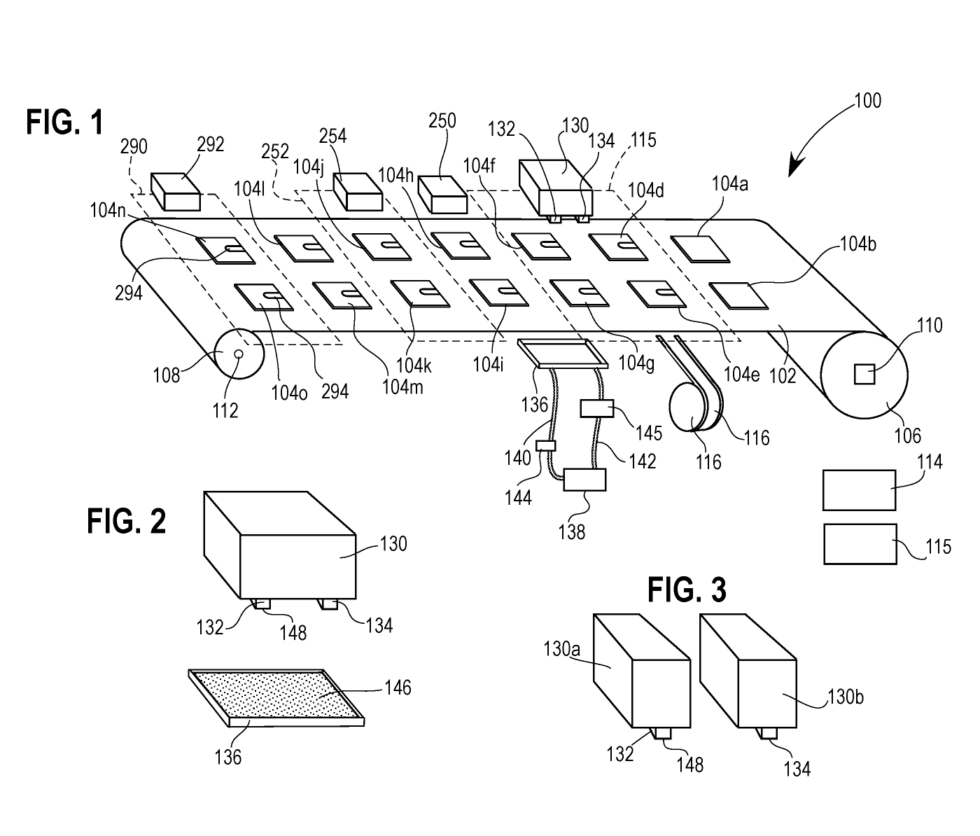

Referring to FIGS. 1 and 2, a component placement system 100 for placing components on a printed circuit board, as described above, is adapted to place components on a flexible medium 102 having electronic circuits 104 thereon. The flexible medium 102 may be a web of paper, a polymer, a plastic, and the like. The electronic circuits 104 may include one or more conductive traces printed on the flexible medium 102 using, for example, inkjet, lithography, flexography, foil transfer, and the like. Further, each electronic circuit, for example, the electronic circuit 104a, may be discrete and conductively disconnected from the other electronic circuits, for example, 104b through 104m. In some embodiments, each electronic circuit 104 may be used in a separate electronic device.

The flexible medium 102 may be provided as web on a supply roll 106, wherein the web is pre-printed with conductive traces of electronic circuits 104. After the electronic circuits 104 printed on the flexible medium 102 are populated with components, the flexible medium 102 may be wound on a take up roll 108. The supply roll 106 and the take up roll 108 may be supported on stands (not shown) and coupled to motors 110 and 112, respectively. A controller 114 may operate such motors 110 and 112 to hold the web of the flexible medium 102 between the supply roll 106 and the take up roll 108 at a predetermined tension. Some embodiments of the component placement system 100 may include a separate web tension control module 115 to monitor and actively control the tension of the web of the flexible medium 102. In some embodiments, the predetermined tension of the flexible medium 102 is held at between approximately 5 pounds and approximately 25 pounds of force. In some cases such predetermined tension is approximately 10 pounds of force.

The controller 114 operates the motors 110 and 112 in synchrony to transport the flexible medium such that conductive traces on which components are to be placed, for example, the conductive traces of the electronic circuits 104d-104g, are situated in a component placement area 115 of the component placement system 100.

As described above, the component placement system 100 may include one or more reel supports (not shown) on which reels 116 of tape having components may be mounted. The component reels 116 are coupled to motors (not shown) that may be operated by the controller 114.

In some embodiments, the component placement system 100 is adapted to include a movable placement subassembly 130 that has an adhesive applicator or head 132 and a pick-and-place head 134. The component placement system 100 is further adapted to include an adhesive pan 136 coupled to an adhesive supply 138 by an adhesive supply line 140 and an adhesive return line 142. A pump 144 is disposed along the adhesive supply line 140 to transport adhesive from the adhesive supply 138 to the adhesive pan 136. Excess adhesive in the adhesive pan 136 may be returned to the adhesive supply 138 by the adhesive return line 142. In some embodiments, the adhesive supply 138 may be positioned closer to the ground relative to the adhesive pan 136, so that gravity facilitates transport of the adhesive through the adhesive return line 142. In other embodiments, a negative pressure may be applied to the adhesive supply 138 or a pump 145 may be used to facilitate transport of the adhesive to the adhesive supply 138.

As described in greater detail below, the adhesive pan 136 is configured to maintain a substantially fixed distance between a top surface 146 of the adhesive in such adhesive pan 136 and a contact surface 148 of the adhesive head 132.

In operation, the controller 114 operates the placement subassembly 130 to bring the contact surface 148 of the adhesive head 132 into contact with the top surface 146 of the adhesive in the adhesive pan 136. The controller 114 then operates the placement subassembly 130 so that the adhesive on the contact surface 148 is brought into contact with a location on the conductive trace of the electronic circuit 104 where a component is to be placed, and thereby deposit a dab of adhesive at such location.

Thereafter, the controller 114 operates the placement subassembly 130 to bring the pick-and-place head 134 into contact with a component disposed on a tape wound on a component reel 116. The pick-and-place head 134 may use suction to separate the component from the tape and to hold the component. The pick-and-place head 134 moves the component into contact with the adhesive deposited on the conductive trace of the electronic circuit 104. The controller 114 thereafter releases the suction so that the component is released from the pick-and-place head 134 and remains on the conductive trace. The component may be held in place on the electronic circuit 104 by the dab of adhesive.

Referring to FIG. 3, in some embodiments, the placement subassembly 130 may be replaced with a first placement subassembly 130a and a second placement subassembly 130b. The adhesive head 132 may be disposed on the first placement subassembly 130a, and the pick-and-place head may be disposed on the second placement subassembly 130b. The controller 114 may be configured to operate the first placement subassembly 130a to transport and deposit the dab of adhesive from the adhesive pan 136 to the conductive trace of the electronic circuit 104, and to operate the second placement subassembly 130b to pick up and transport the component from the component reel 116 to the conductive trace of the electronic circuit 104.

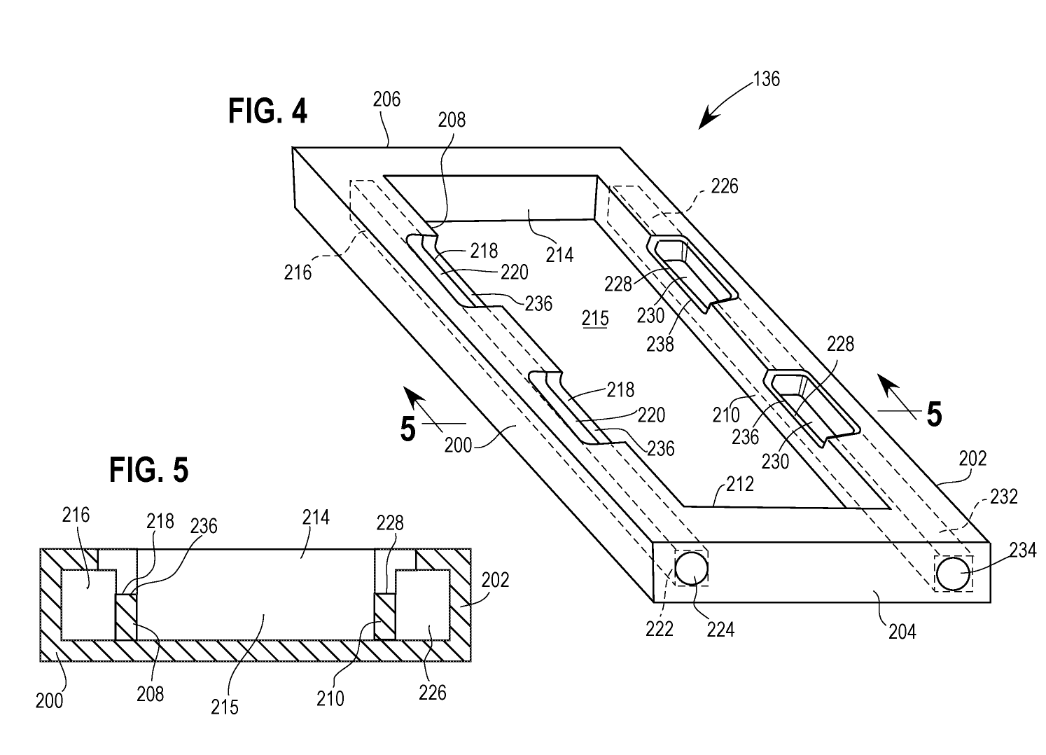

Referring to FIGS. 4 and 5, in one embodiment, the adhesive pan 136 includes a first exterior sidewall 200 and a second exterior sidewall 202. A third exterior sidewall 204 extends between the first exterior sidewall 200 and the second exterior sidewall 202. A fourth exterior sidewall 206 also extends between the first exterior sidewall 200 and the second exterior sidewall 202.

In some embodiments, the first exterior sidewall 200 and the second exterior sidewall 202 may be substantially parallel to one another, and/or the third exterior sidewall 204 and the fourth exterior sidewall 206 may be substantially parallel to one another.

The adhesive pan 136 further includes a first interior sidewall 208 and a second interior sidewall 210. A third interior sidewall 212 and a fourth interior sidewall 214 extend between the first interior sidewall 208 and the second interior sidewalls 210. The first interior sidewall 208, the second interior sidewall 210, the third interior sidewall 212, and the fourth interior sidewall 214 define a receptacle 215 in an interior of the adhesive pan 136 into which an adhesive material may be disposed.

In some embodiments, the first interior sidewall 208 may be substantially parallel to the second interior sidewall 210, and/or the third interior sidewall 212 may be substantially parallel to the fourth interior sidewall 214.

A channel 216 may be disposed between the first exterior sidewall 200 and the first interior sidewall 208. In some embodiments, the channel 216 may be substantially parallel to one or both of the first exterior sidewall 200 and the first interior sidewall 208. The first interior sidewall 208 includes rectangular notches 218, and each such rectangular notch 218 forms an opening 220 that couples the channel 216 with the receptacle 215.

One end 222 of the channel 216 may terminate in a port 224 in the third exterior sidewall 204. The adhesive supply line 140 (FIG. 1) may be coupled to the port 224. Adhesive from the adhesive supply 138 (FIG. 1) may be transported through the adhesive supply line 140, into the channel 216, through the openings 220, and into the receptacle 215.

Another channel 226 may be disposed between the second exterior sidewall 202 and the second interior sidewall 210. In some embodiments, the channel 226 may be parallel to one or both of the second exterior sidewall 202 and the second interior sidewall 210. The second interior sidewall 210 includes rectangular notches 228, and each such notch 228 forms an opening 230 that couples the receptacle 215 and the channel 226.

One end 232 of the channel 226 may terminate in a port 234 in the third exterior sidewall 204. The adhesive return line 142 (FIG. 1) may be coupled to the port 234.

Referring to FIGS. 1, 4 and 5, during operation, the pump 144 may be operated to pump adhesive from the adhesive supply 138, through the adhesive supply line 140, and into the channel 216. Adhesive overflows a lateral edge 236 of each rectangular notch 218, and into the receptacle 215. Any excess adhesive in the receptacle 215 overflows a lateral edge 238 of each rectangular notch 228, and enters the channel 226. Such excess adhesive flows through the channel 226, through the adhesive return line 142, to the adhesive supply 138. Because such excess adhesive is returned to the adhesive supply 138, the top surface of the adhesive 146 may be prevented from rising substantially beyond the lateral edge 238 of each rectangular notch 228. Such rectangular notches 228 may be disposed in the second interior sidewall 210 such that the lateral edges 228 of such notches are collinear. Further, referring also to FIG. 1, the adhesive pan 136 may be disposed in the component placement system 100 such that the lateral edge 238 may be at a predetermined distance from the contact surface 148 of the adhesive head 132, thereby the top surface 146 of the adhesive in the adhesive pan 136 also may be kept at a predetermined distance from the contact surface 148. Maintaining such a fixed distance may allow control over how much adhesive is picked up by the contact surface 148 when such surface contacts the contact surface 148.

Continuous recirculation of the adhesive between the adhesive supply 138 and the adhesive pan 136 as described above may also facilitate keeping the adhesive fluid, and prevent the adhesive from solidifying or components of the adhesive settling in the adhesive pan 136.

Referring once again to FIG. 1, after components are deposited on the electronic circuits 104 on the flexible medium 102, such electronic circuits 104 with the components thereon are transported past a dryer 250 such as, for example, a radiant heater. The dryer 250 is operated to evaporate moisture, for example water or other solvent component(s), in the adhesive used to secure the component(s) on the electronic circuit. In some embodiments, the dryer 250 is operated to heat the adhesive to between approximately 60 degrees Celsius and approximately 90 degrees Celsius.

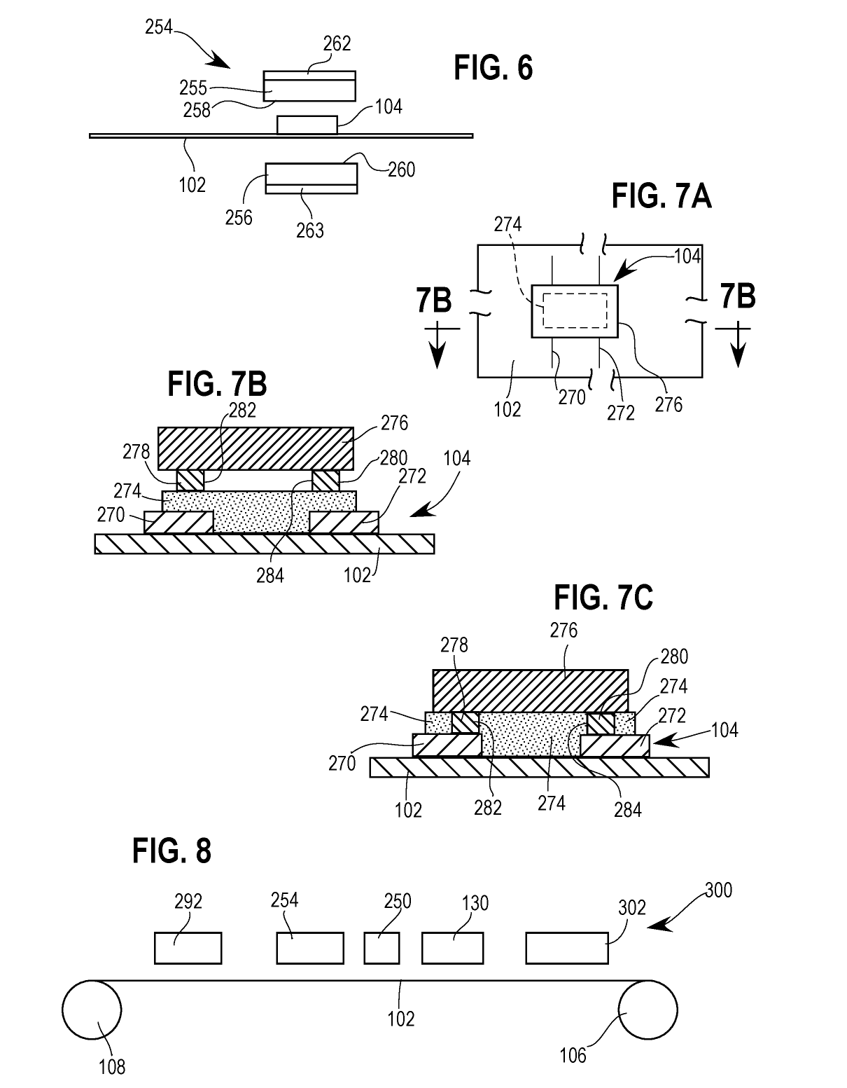

Referring also to FIG. 6, after being at least partially dried by the dryer 250, the flexible medium 102 is transported to a pressure application area 252 in which a pressure applicator 254 is disposed. In one embodiment, the pressure applicator 254 includes a pressure plate 255 and a counter pressure plate 256. The pressure applicator 254 and/or the electronic circuit 104 are moved relative to one another so that the electronic circuit 104 may be positioned between a face 258 of the pressure plate 255 and a face 260 of the counter pressure plate 256. The pressure plate 255 and/or the counter pressure plate 256 are moved so that the faces 258 and 260 thereof move toward one another and apply mechanical pressure to the electronic circuit 104 disposed therebetween. Simultaneously, heaters 262 and/or 263 may be operated to heat one or both of the faces 258 and 260, respectively, to apply heat to the electronic circuit 104.

In some embodiments, the controller 114 monitors the position of the web of flexible medium 102 and actuates the pressure applicator 254 when an electronic circuit 104 disposed on the web of the flexible medium 102 is between the pressure plate 255 and the counter pressure plate 256. In some embodiments, the controller 114 actuates pneumatic lifters (not shown) coupled to the pressure plate 255 and/or the counter pressure plate 256 to apply pressure to the electronic circuit 114.

The pressure plate 255 and the counter pressure plate 256 apply pressure and heat substantially uniformly to the entire surface of the electronic circuit 104. Such uniform pressure and heat may prevent bending a portion of the electronic circuit 104 relative to another portion thereof, which may break and/or otherwise damage the conductive traces of the electronic circuit 104.

In some embodiments, the pressure applicator 254 may be moveable within pressure application area 252. In such embodiments, the pressure applicator 254 may be transported sequentially to each discrete electronic circuit 104 in the pressure application area 252, and operated to apply pressure and/or heat to such electronic circuit 104.

The pressure and/or heat applied to the electronic circuit 114 facilitate(s) formation of a bond between the components placed on such circuit with conductive traces of such circuit.

Referring to FIGS. 7A, 7B and 7C, the electronic circuit 104 includes a first conductive trace 270 and a second conductive trace 272. The first conductive trace 270 and the second conductive trace 272 may be conductive materials such as copper, aluminum, silver, another metal, or a non-metal.

As described above, a dab of adhesive 274 may be placed on top of the first conductive trace 270 and the second conductive trace 272, and a component 276 may be placed on top of the dab of adhesive 274. The component 276 may have a first pin 278 and a second pin 280 coupled thereto. The first pin 278 and second pin 280 may be manufactured from, for example, tin, or another conductive material. In a preferred embodiment, the adhesive is selected to have a melting point that is lower than that of the material from which the first pin 278 and the second pin 280 are manufactured.

In one embodiment, when the pressure applicator 254 applies the heat and pressure, the heat initially causes the dab of adhesive 274 to reach the melting point thereof. The pressure then urges the first pin 278 and the second pin 280 through the molten dab of adhesive 274 so that the first pin 278 and the second pin 280 contact the first conductive trace 270 and the second conductive trace 272, respectively. As the heaters 262 and 263 continue to apply additional heat to the electronic circuit 104, an outer portion (e.g., an outer surface) 282 of the first pin 278 and an outer portion (e.g., an outer surface) 284 of the second pin 280 reach the melting point thereof, and melt onto the conductive trace 270 and 272, respectively. In some embodiments, the outer portion 282 and the remainder of the first pin 278 may be made from an identical material. In other embodiments, the outer portion 282 of the first pin may be made from a material that is different than that used for the remainder of the first pin 278. In some cases, the melting point of the outer portion 282 may be different than the melting point of the remainder of the first pin 278. For example, the output portion 282 may comprise a coating that is applied to the remainder of the first pin 278. Similarly, the outer portion 282 of the second pin 280 and the remainder of the second pin 280 may be made from identical or different materials.

Thereafter, after the heat and pressure are removed, and the electronic circuit 104 cools, the first pin 278 and the second pin 280 also cool and solidify. Through such melting and solidifying when in contact with the conductive traces 270 and 272, the pins 278 and 280 securely bond and electrically couple with the first conductive trace 270 and the second conductive trace 272, respectively.

In some embodiments, the faces 258 and 260 are urged against one another to apply a pressure of approximately 30 pounds per square inch to the electronic circuit 104. Further, the heaters 262 and/or 263 are operated to heat the faces 258 and/or 260, respectively, to a temperature of approximately 150 degrees Celsius. In one embodiment, the pressure applicator 254 may be operated to apply heat and pressure to the electronic circuit 104 for approximately 10 seconds.

In one embodiment, the adhesive is selected so that the dab of adhesive 274 melts at between approximately 65 and 82 degrees Celsius. In some embodiments, the pins 278 and 280 are manufactured from tin and melt at between 112 and 115 degrees Celsius. Materials that melt at other temperatures and that are apparent to those who have skill in the art may be used to supply the dab of adhesive 274 and the pins 278 and 280.

Referring once again to FIG. 1, after pressure has been applied to the electronic circuits 104, the electronic circuits 104 are transported to a programming region 290. In the programming region, a data downloader 292 downloads program instructions to the electronic circuits 104n,104o in the region 290. The data downloader 292 may be a device that can communicate via a serial-peripheral interface, a universal bus interface, or the like, and includes a connector (not shown) that couples with a suitable data port 294 disposed on the electronic circuit 104. In some embodiments the data downloader 292 may be moveable within the programming region 290, and the controller 114 coordinates the movement of the data downloader 292, for example by actuating motors (not shown), to each electronic circuit 104n,104o in the programming region 290.

In some embodiments, the data downloader 292 may be an RFID writing device, and each of the electronic circuits 104 may includes an RFID transponder (not shown). In such embodiments, the data downloader 292 downloads the program instructions to a memory of the electronic circuit 104 via the RFID transponder without contacting the electronic circuit 104.

Referring once again to FIGS. 1-3, in some embodiments the adhesive head 132 may be a printhead that can dispense the adhesive. For example, an inkjet printhead may be supplied with the adhesive and used to selectively deposit drops of the adhesive on the electronic circuit 104.

Referring to FIGS. 1 and 8, another embodiment 300 of the component placement system 100 includes a separate printhead 302 that deposits drops of the adhesive on the electronic circuit 104. In such embodiment, the placement sub-assembly 130 may include only a pick-and-place head 134 to pick up and place the components on the adhesive deposited by the printhead 302. Alternately, the placement sub-assembly 130 may include an adhesive head 132 that deposits additional adhesive to the flexible medium. In some cases, the placement sub-assembly 130 may include an adhesive head 132 that deposits an additional material that activates or otherwise modifies the properties of the adhesive deposited by the printhead 302.

The controller 114 coordinates the operation of the motors 110 and 112, the placement subassembly 130, the dryer 250, and the pressure applicator 254. For example, the controller 114 may operate the placement subassembly 130 to populate with components all of the electronic circuits 104 in the component placement area 115, and simultaneously operate the pressure applicator 254 to apply pressure to all of the electronic circuit 104 in the pressure application area 252. After both the placement subassembly 130 and the pressure applicator 254 have finished, the controller 114 may turn on the dryer 250 and operate the motors 110 and 112 to advance the flexible medium 102 until another group of electronic circuits 104 is in the component placement area 115. It should be apparent to those of ordinary skill that such simultaneous operation may improve the efficiency with which electronic circuits having components placed and secured thereto may be produced.

### INDUSTRIAL APPLICABILITY

The system and method described above may be used to produce electronic circuits incorporated in a number of products. For example, such products may include container labels, greeting cards, books, advertising or information labels, and the like.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. It should be understood that the illustrated embodiments are exemplary only, and should not be taken as limiting the scope of the disclosure.

We claim:

1. An apparatus to place components on an electronic circuit, wherein the electronic circuit is disposed on a flexible medium, comprising:
an adhesive applicator adapted to deposit an adhesive on the electronic circuit;
a component pick-and-place head adapted to place a component on the adhesive; and
a heater, wherein the heater is adapted to supply sufficient heat to the electronic circuit to melt both the adhesive and an outer portion of a contact pin of the component.

2. The apparatus of claim 1, further including a pressure applicator that applies pressure to the electronic circuit while the heater supplies heat to the electronic circuit.

3. The apparatus of claim 2, wherein the pressure applicator applies uniform pressure to the entire electronic circuit.

4. The apparatus of claim 2, further including a dryer that removes moisture from the adhesive before the pressure applicator applies pressure to the electronic circuit.

5. The apparatus of claim 2, wherein operation of the pressure applicator and the heater facilitates conductively coupling the component with a conductive trace of the electronic circuit.

6. The apparatus of claim 2, wherein the flexible medium is a web, and the apparatus further includes transport apparatus adapted to transport the flexible medium.

7. The apparatus of claim 2, wherein the transport apparatus maintains the web at a predetermined tension.

8. The apparatus of claim 7, further including a controller to synchronize operation of the adhesive applicator, the component pick-and-place head, and the pressure applicator, and the transport apparatus.

9. The apparatus of claim 1, further including an adhesive pan adapted to hold an adhesive, wherein a top surface of the adhesive is maintained at a predefined distance from a face of the adhesive applicator.

10. The apparatus of claim 8, wherein the adhesive pan is coupled to an adhesive supply line and an adhesive return line, wherein the adhesive supply line is adapted to deliver adhesive to the adhesive pan, and the adhesive return line is adapted to transport adhesive away from the adhesive pan.

11. The apparatus of claim 9, in combination with an adhesive supply, wherein the adhesive supply line and the adhesive return line are coupled to the adhesive supply.

12. The apparatus of claim 9, wherein the adhesive pan includes a first channel adjacent a first sidewall thereof, a second channel adjacent a second sidewall, wherein the first channel is adapted to deliver adhesive to an interior of the adhesive pan, and the second channel is adapted to remove adhesive from the interior of the adhesive pan.

13. The apparatus of claim 12, wherein the first sidewall includes an edge, wherein adhesive in the first channel flows over the edge and into an interior of the adhesive pan.

14. The apparatus of claim 12, wherein the second sidewall includes an edge, wherein adhesive in the adhesive pan flows over the edge and into the second channel.

15. The apparatus of claim 1, further including a data downloader that transmits program instructions to a memory of the electronic circuit.

16. The apparatus of claim 15, wherein the data downloader transmits the program instructions without contact between the data downloader and the electronic circuit.

17. A method for placing components on an electronic circuit, wherein the electronic circuit is disposed on a flexible medium, comprising:
depositing an adhesive on the electronic circuit;
placing a component on the adhesive;
applying sufficient heat to the electronic circuit to melt the adhesive and melt an outer portion of a contact pin of the component.

18. The method of claim 17, wherein the step of applying heat includes the step of applying pressure to the electronic circuit.

19. The method of claim 18, wherein the step of applying pressure includes the step of applying a uniform pressure to the entire electronic circuit.

20. The method of claim 18, wherein the step applying pressure includes the step of conductively coupling the component and a conductive trace of the electronic circuit.

21. The method of claim 18, further including the step of evaporating moisture from the adhesive before undertaking the step of applying sufficient heat.

22. The method of claim 17, further including the steps of transporting the flexible medium, and maintaining the flexible medium at a predetermined tension.

23. The method of claim 20, further including the step of synchronizing the steps of applying the adhesive, placing the component, applying heat, applying pressure, and transporting the web.

24. The method of claim 17, further including the steps of holding an adhesive in an adhesive pan, and maintaining a top surface of the adhesive in the adhesive pan at a predefined distance from a face of an adhesive applicator that deposits the adhesive.

25. The method of claim 24, further including delivering adhesive to the adhesive pan via an adhesive supply line and removing adhesive from the adhesive pan via an adhesive return line.

26. The method of claim 25, further including the step of coupling the adhesive supply line and the adhesive return line to an adhesive supply.

27. The method of claim 17, further including the step of downloading program instructions to a memory of the electronic circuit.
